(19) United States
(12) Patent Application Publication
(10) Pub. No.: US 2009/0253473 A1
(43) Pub. Date: Oct. 8, 2009

(54) Wireless transceiver device and wireless headset

(76) Inventor: Ane-Li Jow, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,650

(22) Filed: Oct. 10, 2008

(30) Foreign Application Priority Data
Apr. 3, 2008 (TW) 97112198

(51) Int. Cl. H04M 1/00

(52) U.S. Cl. 455/575.2

(57) ABSTRACT

A wireless transceiver device includes a wireless transceiver unit, a signal transformer, an audio amplifier and a power supply device. The wireless transceiver unit is used for receiving and transmitting audio signals. The signal transformer is connected to the wireless transceiver unit and used for transforming the audio signals into digital signals or analog signals. The audio amplifier is connected to the signal transformer and used for amplifying and outputting the audio signals into a second audio output device. The power supply device supplies power to the wireless transceiver device. When the wireless transceiver device is being charged or in idle state, it can function as an audio amplifier to drive an external or built-in audio output device.

### BACKGROUND OF THE INVENTION

1. Field of the Invention

The present invention relates to a wireless transceiver device and wireless headset, and more particularly to a wireless transceiver device and wireless headset which can function as an audio amplifier.

2. Description of the Prior Art

The convenience provided by wireless communication technology makes its applications, for example, in a wireless headset, widely popular. For example, almost all mobile phones support Bluetooth communications standard, and the Bluetooth headset may be applied to wirelessly communicate with Bluetooth mobile phones.

For avoiding the use of the power cable to supply power to the wireless headset to enjoy the portability of the wireless headset, batteries may be used to supply power to the wireless headset. Furthermore, in order to reduce the cost and/or environmental concerns caused by the use of conventional batteries some manufacturers proposed using built-in rechargeable battery. However, when the wireless headset is being charged, it will not be able to perform the normal functions of the headset. Furthermore, the wireless headset of the mobile phones is exclusively used to answer phone or communicate via the mobile phone, and remains idle when not communicating via the mobile phone.

Accordingly, how to make use of wireless headset in idle state, and also while it is being charged is highly desirable.

### SUMMARY OF THE INVENTION

The present invention is directed to a wireless transceiver device and wireless headset including an audio amplifier for amplifying audio signals. When being charged or in idle state, the wireless transceiver device and the wireless headset can function as an audio amplifier to drive an external or built-in audio output device.

In one embodiment, the wireless transceiver device including a first audio output device and an audio input device to implement a function of a wireless headset comprises a wireless transceiver unit for receiving and transmitting audio signals; a signal transformer coupled to the wireless transceiver unit for transforming the audio signals into digital signals or analog signals; an audio amplifier coupled to the signal transformer for amplifying and outputting the digital signals or the analog signals to a second audio output device; and an electric power supply device for providing power to the wireless transceiver device.

In another embodiment, the wireless headset includes a wireless transceiver unit for receiving and transmitting audio signals; a signal transformer coupled to the wireless transceiver unit for transforming the audio signals into digital signals or analog signals; a first audio output device coupled to the signal transformer for outputting the audio signals; an audio input device coupled to the signal transformer for receiving the audio signals; an audio amplifier coupled to the signal transformer for amplifying and outputting the digital signals or the analog signals to a second audio output device; and an electric power supply device for providing power to the wireless headset.

Other advantages of the present invention will become apparent from the following description taken in conjunction with the accompanying drawings, which are set forth by way of illustration and example, to certainly embody the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram illustrating a wireless transceiver device and wireless headset according to one embodiment of the present invention; and

FIG. 2 is a schematic diagram illustrating a wireless transceiver device and wireless headset according to another embodiment of the present invention.

### DESCRIPTION OF THE PREFERRED EMBODIMENT

The detailed explanation of the present invention is described as following. The described preferred embodiments are presented for purposes of illustrations and description, and they are not intended to limit the scope of the present invention.

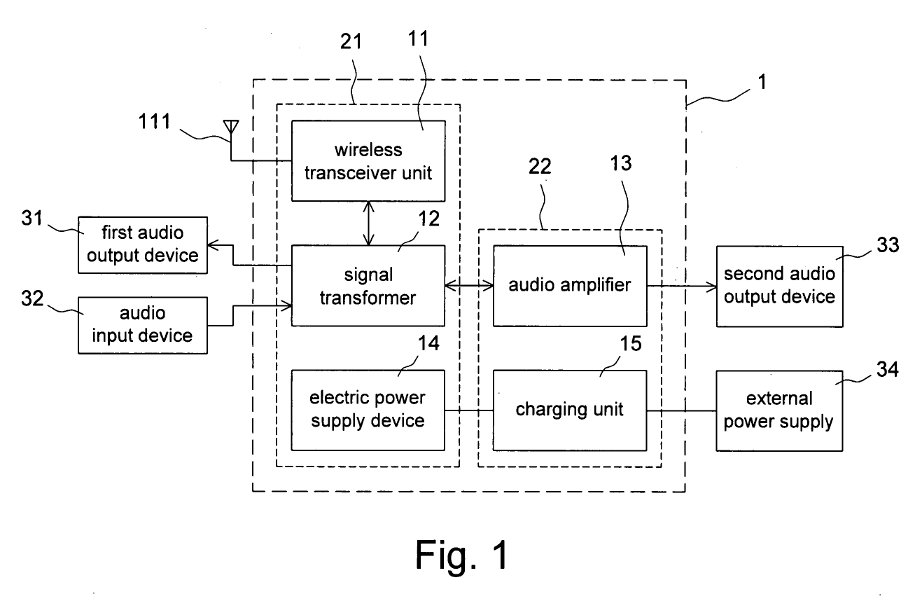

FIG. 1 is a schematic diagram illustrating a wireless transceiver device according to one embodiment of the present invention. The wireless transceiver device 1 including a first audio output device 31 and an audio input device 32 to implement a function of a wireless headset comprises a wireless transceiver unit 11, a signal transformer 12, an audio amplifier 13, and an electric power supply device 14. The wireless transceiver unit 11 receives and transmits audio signals from/to an antenna 111. For example, the wireless transceiver unit 11 is implemented with Bluetooth, Ultra Wide Band (UWB) or IEEE 802.11 series protocol for various wireless communication applications.

The signal transformer 12 is coupled to the wireless transceiver unit 11 and transforms the audio signals into digital signals or analog signals. In one embodiment, the signal transformer 12 receives the audio signals from the wireless transceiver unit 11, and transforms the audio signals into analog signals and outputs the analog signals to the first audio output device 31; or the audio signals input from audio input device 32 are transformed into digital signals, and then output to the wireless transceiver unit 11.

The audio amplifier 13 is coupled to the signal transformer 12 and amplifies and outputs the audio signals to a second audio output device 33. For example, the second audio output device 33 may be a speaker. It should be noted that the audio amplifier 13 is not limited to amplify audio signals with digital or analog format. In one embodiment, the signal transformer 12 and the audio amplifier 13 comply with data transmission protocol of Inter-IC Sound (I2S), Sony/Philips Digital Interface Format (S/PDIF), or Pulse Code Modulation (PCM) to communicate each other.

The electric power supply device 14 provides power to the wireless transceiver device for operation. In one embodiment, the electric power supply device 14 in the wireless transceiver device 1 may be a rechargeable battery or a one-time-use battery. The wireless transceiver device 1 may further include a charging unit 15 coupled to the electric power supply device 14, and an external power supply 34 may be connected to the charging unit 15 to charge the electric power supply device 14.

Still referring to FIG. 1, in one embodiment, the wireless transceiver unit 11, the signal transformer 12 and the electric power supply device 14 may be disposed in an outer shell 21, and the audio amplifier 13 and charging unit 15 may be disposed in a dock 22, wherein the electric power supply device 14 is electrically connected to the charging unit 15 and the outer shell 21 is movable relative to the dock 22. The wireless transceiver device 1, the first audio output device 31 and the audio input device 32 together function as a wireless headset. For charging power to the wireless transceiver device 1, the external power supply 34 is electrically connected to the charging unit 15 to charge the electric power supply device 14. The wireless transceiver device 1, at the time of being charged, can also function as an audio amplifier to output the audio signals to the second audio output device 33.

Alternatively, in one embodiment, the wireless transceiver unit 11, the signal transformer 12, the audio amplifier 13, the electric power supply device 14 and the charging unit 15 may be disposed in a body, and the electric power supply device 14 may be electrically connected to the external power supply 34 via charging unit 15 to charge the wireless transceiver device 1. Moreover, the second audio output device 33 may be disposed in the body or the dock 22 to serve as a built-in audio output device. Alternatively, the second audio output device 33 may be an externally connected audio output device.

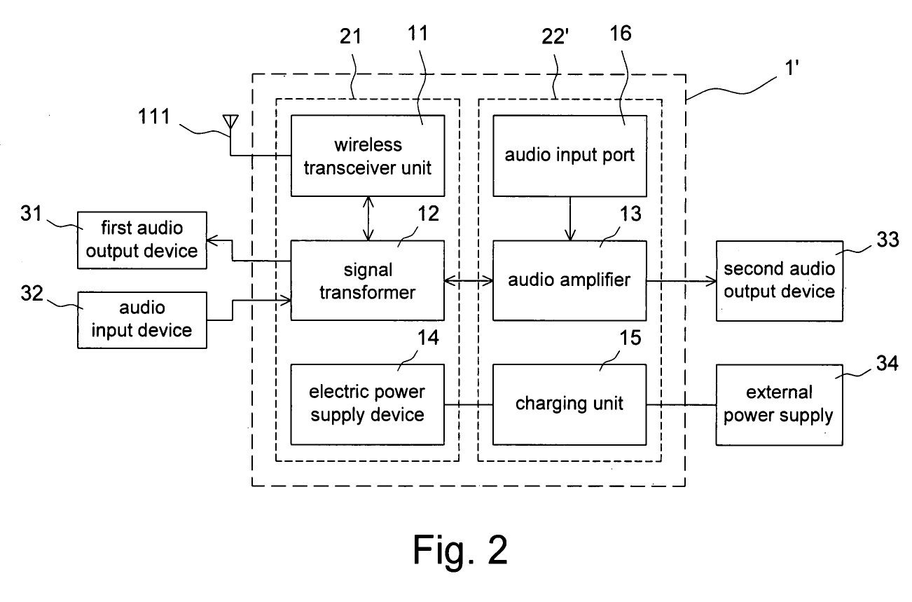

FIG. 2 is a schematic diagram illustrating a wireless transceiver device and wireless headset according to another embodiment of the present invention. The wireless transceiver device 1′ further includes an audio input port 16 coupled to the audio amplifier 13. Any audio player may be connected to the audio input port 16 in the wireless transceiver device 1′ and the external second audio output device 33 may be driven by the audio amplifier 13 in the dock 22′. The audio signals can be input from the wireless transceiver unit 11 or the audio input port 16 through wireless or wired transmission, and the audio signals may be output to the first audio output device 31 and/or the second audio output device 33.

It should be noted that the audio input port 16 may be further coupled to the signal transformer 12 for receiving the audio signals and outputting the audio signals to the first audio output device 31 and/or the second audio output device 33.

Furthermore, according to an embodiment of the present invention, a structure of a wireless headset may be described with reference to FIG. 1, which includes the wireless transceiver unit 11, the signal transformer 12, the audio amplifier 13, the electric power supply device 14, the first audio output device 31 and the audio input device 32. Because the details of the wireless transceiver unit 11, the signal transformer 12, the audio amplifier 13, and the electric power supply device 14 have been described above, and therefore detail description thereof will not be repeated hereinafter. The first audio output device 31 is coupled to the signal transformer 12 for outputting the audio signals. The audio input device 32 is coupled to the signal transformer 12 for receiving the audio signals.

In one embodiment, the first audio output device 31 may be a headset, such as headphones, earphones. The audio input device 32 may be a microphone. For example, the first audio output device 31 and the audio input device 32 are movable and electrically connected to the signal transformer 12.

In summary, the wireless transceiver device or the wireless headset includes an audio amplifier to drive the external or built-in audio output device while being in charging or idle state. In addition, the audio playback devices can also be wirelessly connected to the audio output device of wireless transceiver device or wireless headset.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A wireless transceiver device, including a first audio output device and an audio input device to implement a function of a wireless headset, comprising:
a wireless transceiver unit, for receiving and transmitting audio signals;
a signal transformer, coupled to the wireless transceiver unit and transforming the audio signals into digital signals or analog signals;
an audio amplifier, coupled to the signal transformer, for amplifying and outputting the digital signals or the analog signals to a second audio output device; and
an electric power supply device, for providing power to the wireless transceiver device for operation.

2. The wireless transceiver device as claimed in claim 1, further comprising a charging unit coupled to the electric power supply device, and an external power supply is electrically connected to the charging unit to charge the electric power supply device.

3. The wireless transceiver device as claimed in claim 2, wherein the wireless transceiver unit, the signal transformer, the audio amplifier, the electric power supply device and the charging unit are disposed in a body.

4. The wireless transceiver device as claimed in claim 2, wherein the wireless transceiver unit, the signal transformer and the electric power supply device are disposed in an outer shell, and the audio amplifier and charging unit are disposed into a dock, wherein the electric power supply device is electrically connected to the charging unit and the outer shell is movable relative to the dock.

5. The wireless transceiver device as claimed in claim 1, further comprising an audio input port coupled to the audio amplifier and/or the signal transformer for receiving the audio signals and outputting the audio signals to the first audio output device and/or the second audio output device.

6. The wireless transceiver device as claimed in claim 1, wherein the electric power supply device comprises a rechargeable battery or a one-time-use battery.

7. The wireless transceiver device as claimed in claim 1, wherein the signal transformer and the audio amplifier comply with data transmission standard of Inter-IC Sound (I2S), Sony/Philips Digital Interface Format (S/PDIF), or Pulse Code Modulation (PCM).

8. The wireless transceiver device as claimed in claim 1, wherein the wireless transceiver unit is implemented with Bluetooth, Ultra Wide Band (UWB) or IEEE 802.11 series protocol.

9. The wireless transceiver device as claimed in claim 1, wherein the second audio output device is a built-in audio output device or an external audio output device.

10. The wireless transceiver device as claimed in claim 1, wherein the second audio output device comprises a speaker.

11. A wireless headset, comprising:
a wireless transceiver unit, for receiving and transmitting audio signals;
a signal transformer, coupled to the wireless transceiver unit, for transforming the audio signals into digital signals or analog signals;
a first audio output device, coupled to the signal transformer, for outputting the audio signals;
an audio input device, coupled to the signal transformer, for receiving the audio signals;
an audio amplifier, coupled to the signal transformer, for amplifying and outputting the digital signals or the analog signals to a second audio output device; and
an electric power supply device, for providing power to the wireless headset for operation.

12. The wireless headset as claimed in claim 11, further comprising a charging unit coupled to the electric power supply device, and an external power supply is electrically connected to the charging unit to charge the electric power supply device.

13. The wireless headset as claimed in claim 12, wherein the wireless transceiver unit, the signal transformer, the audio amplifier, the electric power supply device and the charging unit are disposed in a body.

14. The wireless headset as claimed in claim 12, wherein the wireless transceiver unit, the signal transformer and the electric power supply device are disposed in an outer shell, and the audio amplifier and the charging unit are disposed in a dock, wherein electric power supply device is electrically connected to the charging unit and the outer shell is movable relative to the dock.

15. The wireless headset as claimed in claim 11, further comprising an audio input port coupled to the audio amplifier and/or the signal transformer for receiving the audio signals and outputting the audio signals to the first audio output device and/or the second audio output device.

16. The wireless headset as claimed in claim 11, wherein the electric power supply device comprises a rechargeable battery or a one-time-use battery.

17. The wireless headset as claimed in claim 11, wherein the signal transformer and the audio amplifier comply with data transmission standard of Inter-IC Sound (I2S), Sony/Philips Digital Interface Format (S/PDIF), or Pulse Code Modulation (PCM).

18. The wireless headset as claimed in claim 11, wherein the wireless transceiver unit is implemented with Bluetooth, Ultra Wide Band (UWB) or IEEE 802.11 series protocol.

19. The wireless headset as claimed in claim 11, wherein the first audio output device and the audio input device are movable and electrically connected to the signal transformer.

20. The wireless headset as claimed in claim 11, wherein the audio input device comprises a microphone, and the first audio output device comprises an earphone.

21. The wireless headset as claimed in claim 11, wherein the second audio output device is a built-in audio output device or an external audio output device.

22. The wireless headset as claimed in claim 11, wherein the second audio output device comprises a speaker.
